(19) United States
(12) Patent Application Publication
(10) Pub. No.: US 2024/0380496 A1
(43) Pub. Date: Nov. 14, 2024

(54) OPTICAL COMMUNICATION DEVICE AND SLEEP CONTROL METHOD

(71) Applicant: NIPPON TELEGRAPH AND TELEPHONE CORPORATION, Tokyo (JP)

(72) Inventors: Ryo MIYATAKE, Musashino-shi, Tokyo (JP); Kenta ITO, Musashino-shi, Tokyo (JP); Hiroaki KATSURAI, Musashino-shi, Tokyo (JP); Yoichi FUKADA, Musashino-shi, Tokyo (JP); Tomoaki YOSHIDA, Musashino-shi, Tokyo (JP)

(73) Assignee: NIPPON TELEGRAPH AND TELEPHONE CORPORATION, Tokyo (JP)

(21) Appl. No.: 18/691,149

(22) PCT Filed: Sep. 17, 2021
(86) PCT No.: PCT/JP2021/034312

§ 371 Date: Mar. 12, 2024

(51) Int. Cl. H04B 10/80; H04J 14/02

(52) U.S. Cl. CPC H04B 10/80; H04J 14/02; H04J 2203/0067; H04J 2203/0098

(57) ABSTRACT

An optical communication device includes: a control signal generation unit that generates, on the basis of a communication log, a sleep cancellation signal including information about at least one time at which communication with a terminal device performing wireless communication with a power-receiving optical communication device is expected to be successful, the communication log including information about a result of communication at a time when sleep state cancellation is performed on the power-receiving optical communication device that is driven by electrical power obtained from an optical signal for power supply; and an optical communication unit that converts the generated sleep cancellation signal into an optical signal, and transmits the optical signal to the power-receiving optical communication device.

### TECHNICAL FIELD

The present invention relates to an optical communication device and a sleep control method.

### BACKGROUND ART

There is a known conventional optical communication device that charges the battery with electrical power obtained by optical power supply, and operates using the power of the charged battery. Such an optical communication device has limited available power, and therefore, is capable of reducing power consumption by sleeping when any signal is not transmitted. However, according to many low power wide area (LPWA) standards such as class A and enocean of long range wide area network (LoRaWAN) (LoRa is a registered trademark), a signal arrives from a terminal device without any advance notice (see Non Patent Literature 1, for example). Therefore, it is difficult to cancel sleep of an optical communication device in time with arrival of a signal.

To counter this, an optical communication device that performs conventional LPWA communication always waits for a signal by power supply driving or the like. However, an optical communication device whose power is limited by optical power supply driving or the like cannot operate at all times.

### CITATION LIST

### Non Patent Literature

Non Patent Literature 1: “IoT jigyou kakudai no tame no LoRaWAN no jigyouka (Commercialization of LoRaWAN for IoT business expansion)”, NTT Technical Journal, [online], [retrieved on Sep. 6, 2021], the Internet <https://journal.ntt.co.jp/article/5426>

### SUMMARY OF INVENTION

### Technical Problem

There are two methods conceivable as methods for receiving an uplink signal of LPWA communication while performing power saving by charging the battery with electrical power obtained by optical power supply or the like with an optical communication device, without the use of any commercial power supply. A first method is a method for activating an optical communication device only when activation is possible, in accordance with the remaining charge amount of the optical communication device. By the first method, it is possible to reduce the power consumption in the optical communication device, but there are cases where the signal reception success rate drops because activation is performed regardless of whether there is the arrival of a signal.

A second method is a method using look-ahead information indicating the transmission cycle of a terminal device that transmits uplink signals. By the second method, an optical communication device acquires information about the transmission cycle of the terminal device as the look-ahead information in some manner, and stores the information about the transmission cycle as a terminal transmission cycle table. After that, the optical communication device refers to the terminal transmission cycle table, and transitions between a sleep state and an activated state, to become active in time with the arrival of a signal transmitted from the terminal device. By the second method, the signal reception success rate is high, but it is difficult to obtain the look-ahead information.

As described above, by conventional techniques, it is not possible to increase the reception success rate of uplink signals with less power in an optical communication device that communicates with a terminal device that transmits uplink signals.

In view of the above circumstances, the present invention aims to provide a technology for increasing the reception success rate of uplink signals with less power in an optical communication device that communicates with a terminal device that transmits uplink signals.

### Solution to Problem

One mode of the present invention is an optical communication device that includes: a control signal generation unit that generates, on the basis of a communication log, a sleep cancellation signal including information about at least one time at which communication with a terminal device performing wireless communication with a power-receiving optical communication device is expected to be successful, the communication log including information about results of communication at a time when sleep state cancellation is performed on the power-receiving optical communication device that is driven by electrical power obtained from an optical signal for power supply; and an optical communication unit that converts the generated sleep cancellation signal into an optical signal, and transmits the optical signal to the power-receiving optical communication device.

One mode of the present invention is a sleep control method that includes: generating, on the basis of a communication log, a sleep cancellation signal including information about at least one time at which communication with a terminal device performing wireless communication with a power-receiving optical communication device is expected to be successful, the communication log including information about results of communication at a time when sleep state cancellation is performed on the power-receiving optical communication device that is driven by electrical power obtained from an optical signal for power supply; and converting the generated sleep cancellation signal into an optical signal, and transmitting the optical signal to the power-receiving optical communication device.

### Advantageous Effects of Invention

According to the present invention, it is possible to increase the reception success rate of uplink signals with less power in an optical communication device that communicates with a terminal device that transmits uplink signals.

### BRIEF DESCRIPTION OF DRAWINGS

FIG. 1 is a diagram illustrating an example configuration of an optical power supply system according to an embodiment.

FIG. 2 is a diagram illustrating a specific configuration of an OLT according to the embodiment.

FIG. 3 is a diagram illustrating a specific configuration of an ONU according to the embodiment.

FIG. 4 is a table illustrating an example of communication logs according to the embodiment.

FIG. 5 is a sequence diagram illustrating the flow of processing to be performed by the optical power supply system according to the embodiment.

FIG. 6 is a flowchart illustrating the flow of a sleep cancellation signal generation process to be performed by the OLT according to the embodiment.

FIG. 7 is a table illustrating an example of estimation results obtained from a learned model.

FIG. 8 is a table illustrating the relationship between estimation results and a threshold according to the embodiment.

### DESCRIPTION OF EMBODIMENTS

The following is a description of an embodiment of the present invention, with reference to the drawings.

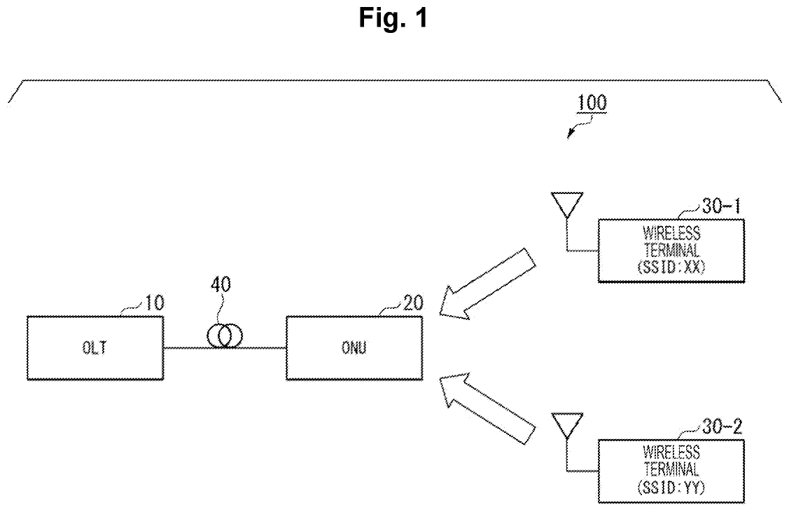

FIG. 1 is a diagram illustrating an example configuration of an optical power supply system 100 according to the embodiment.

The optical power supply system 100 includes an OLT 10 and an ONU 20. The OLT 10 and the ONU 20 are connected via an optical transmission line 40. When the OLT 10 and the ONU 20 are connected via the optical transmission line 40, communication can be performed between the OLT 10 and the ONU 20. For example, the OLT 10 and the ONU 20 are connected via both a power supply line and a communication line.

The power supply line and the communication line may be physically provided in the same fiber, or may be provided in independent fibers. That is, the same fiber may be physically shared by an optical signal for communication and an optical signal for power supply, or independent fiber may be used. In a case where the same fiber is shared by an optical signal for communication and an optical signal for power supply, a method for performing wavelength multiplexing using different frequency bands for the light for communication and the light for power supply may be adopted. In the description below, a configuration in which independent fibers are used for an optical signal for communication and an optical signal for power supply will be explained as an example. In FIG. 1, the OLT 10 and the ONU 20 have a single-star topology configuration. Hereinafter, the direction from the OLT 10 toward the ONU 20 will be referred to as the downlink direction, and the direction from the ONU 20 toward the OLT 10 will be referred to as the uplink direction.

Note that, while FIG. 1 shows one ONU 20, the optical power supply system 100 may include a plurality of ONUs 20. In a case where the optical power supply system 100 includes a plurality of ONUs 20, an optical splitter is provided between the OLT 10 and the plurality of ONUs 20. The optical splitter splits an optical signal transmitted from the OLT 10, and transmits the optical signal to each ONU 20. The optical splitter multiplexes optical signals transmitted from the ONUs 20, and transmits the multiplexed optical signal to the OLT 10.

One or more wireless terminals 30 (wireless terminals 30-1 and 30-2 in FIG. 1) are connected to the ONU 20. The ONU 20 and each wireless terminal 30 perform LPWA communication. The wireless terminals 30 are Internet of Things (IoT) terminals such as sensors, for example. Each wireless terminal 30 transmits a signal in a case where a preset condition is satisfied. The condition may be time, day of the week, data accumulation amount, driving of a sensor attached to the terminal, or the like, for example. That is, the wireless terminal 30-1 and the wireless terminal 30-2 transmit signals to the ONU 20 at different timings, depending on the advance setting.

The OLT 10 is an optical communication device that supplies electrical power for the ONU 20 to operate. To operate the ONU 20 with less power, the OLT 10 cancels sleep of the ONU 20 at an estimated timing at which communication between the ONU 20 and a wireless terminal 30 is successfully performed. For example, the OLT 10 transmits, to the ONU 20, a sleep cancellation signal including information about at least one time at which communication is expected to be successful. The sleep cancellation signal is a signal for canceling a sleep state of some functional units included in the ONU 20.

To estimate a timing at which communication will be successfully performed, the OLT 10 learns the timings of arrivals of signals from the wireless terminals 30 by machine learning. Here, learning is to optimize the coefficients that are used in a machine learning model. For example, learning is to adjust coefficients to be used in a machine learning model, so as to minimize a loss function. The coefficients to be used in the machine learning model are a weight value and a bias value, for example. In an initial stage of learning (a first generation stage of a learned model, for example), the OLT 10 cancels a sleep state of the ONU 20 at random times, and collects logs of communication with the wireless terminals 30, the logs having been obtained by the ONU 20 at the time of the sleep cancellation.

Communication logs are logs related to communication between the ONU 20 and the wireless terminals 30 at times of sleep cancellation, and includes time information (cancellation time information) at times of sleep state cancellation, information about results of communication, and information about the service set identifiers (SSIDs) of the wireless terminals 30 at times of successful communication, for example. The information about results of communication is information indicating whether communication between the ONU 20 and each wireless terminal 30 has succeeded or failed. Successful communication between the ONU 20 and the wireless terminal 30 means that the ONU 20 has received a signal transmitted from the wireless terminal 30. Failed communication between the ONU 20 and the wireless terminal 30 means that the ONU 20 has failed to receive a signal transmitted from the wireless terminal 30.

The OLT 10 uses the collected communication logs to learn the timing at which sleep of the ONU 20 should be canceled to increase the communication success probability by machine learning, and cancels the sleep state of the ONU 20 at the estimated timing at which communication will be successful. Note that the estimated timing at which communication will be successful is a timing at which a signal transmitted from a wireless terminal 30 has a high probability of arriving at the ONU 20.

The ONU 20 drives electrical power supplied as a power supply from the OLT 10. To operate with less power, the ONU 20 operates in a sleep state, unless it is a timing designated from the OLT 10. For example, the ONU 20 transitions from a sleep state to an operable state at a time indicated by the time information included in the sleep cancellation signal transmitted from the OLT 10. The ONU 20 records the communication log at the time when the ONU 20 transitions from the sleep state to the operable state (when the sleep state is canceled), and transmits the recorded communication log to the OLT 10.

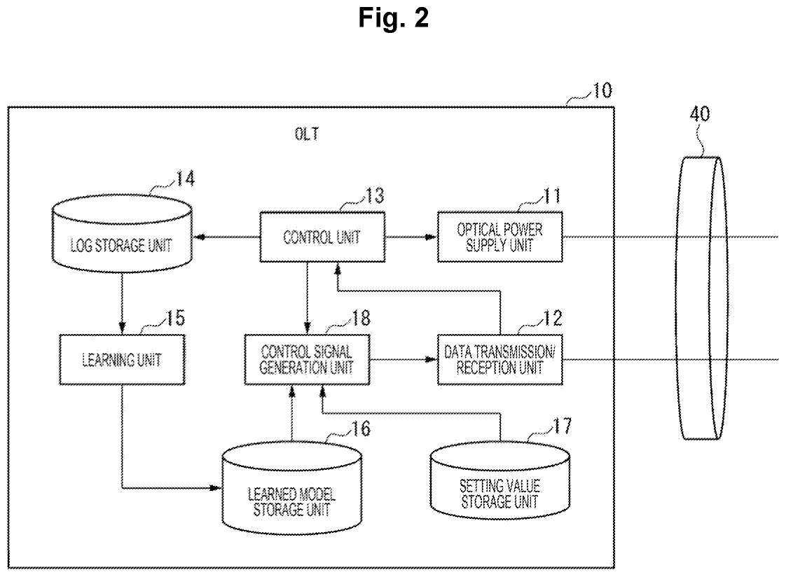

FIG. 2 is a diagram illustrating a specific configuration of the OLT 10 according to the embodiment. The OLT 10 includes an optical power supply unit 11, a data transmission/reception unit 12, a control unit 13, a log storage unit 14, a learning unit 15, a learned model storage unit 16, a setting value storage unit 17, and a control signal generation unit 18.

The optical power supply unit 11 includes a light source that emits power supply light therein, and generates the power supply light from the light source and transmits the power supply light to the optical transmission line 40. Thus, the optical power supply unit 11 transmits the power supply light to the ONU 20. As the power supply light, an optical signal having no temporal changes at a constant voltage is used, for example.

The data transmission/reception unit 12 transmits and receives data to and from the ONU 20. The data transmission/reception unit 12 includes an optical transceiver, for example, and includes a light source that emits light of a specific wavelength inside. The data transmission/reception unit 12 converts an optical signal of transmission data (hereinafter referred to as “communication light”) by modulating light emitted from the light source provided therein on the basis of an electrical signal that is a sleep cancellation signal generated by the control signal generation unit 18, and transmits the converted communication light to the optical transmission line 40.

The data transmission/reception unit 12 further includes an optical/electrical (O/E) converter such as a photodetector therein. The data transmission/reception unit 12 receives an optical signal of a communication log received via the optical transmission line 40, converts the received optical signal of the communication log into an electrical signal with the O/E converter, and outputs the electrical signal to the control unit 13.

The control unit 13 controls operations of the respective functional units included in the OLT 10. For example, the control unit 13 causes the optical power supply unit 11 to output power supply light. For example, the control unit 13 controls the control signal generation unit 18 to generate the sleep cancellation signal.

The log storage unit 14 stores the communication log transmitted from the ONU 20. The log storage unit 14 is formed with a storage device such as a magnetic storage device or a semiconductor storage device.

On the basis of the communication log stored in the log storage unit 14, the learning unit 15 generates a learned model that has been learned to output a result of estimation of the reception success rate of the ONU 20 at each time indicated by input period information, the input being period information regarding the period during which estimation is to be performed to cancel sleep (this period information will be hereinafter referred to as the “estimation target period”). Specifically, the learning unit 15 generates a learned model, using learning data that is the time information at a time of sleep state cancellation, and training data that is the SSIDs of the wireless terminals 30 and information about results of communication. The estimation target period is set beforehand as “estimation at one-second intervals till five seconds ahead of the current time”.

The learning algorithm to be used in the learning unit 15 is a supervised learning model, such as a neural network or deep learning, for example. Note that the learning algorithm may be reinforcement learning, or a classical machine learning method (such as linear regression, logistic regression, support vector machine, decision tree, random forest, or simple Bayes), for example.

The learned model storage unit 16 stores the learned model generated by the learning unit 15. The learned model storage unit 16 is formed with a storage device such as a magnetic storage device or a semiconductor storage device.

The setting value storage unit 17 stores a threshold to be used when the control signal generation unit 18 generates the sleep cancellation signal, and information about the amount of power to be consumed by one sleep cancellation process in the ONU 20 (this information will be hereinafter referred to as the “power consumption information”). The setting value storage unit 17 is formed with a storage device such as a magnetic storage device or a semiconductor storage device.

On the basis of the communication log, the control signal generation unit 18 generates the sleep cancellation signal including information about at least one time at which communication between the ONU 20 and the wireless terminals 30 is expected to be successful. More specifically, the control signal generation unit 18 generates the sleep cancellation signal on the basis of the learned model stored in the learned model storage unit 16, the threshold and the power consumption information stored in the setting value storage unit 17, information about the remaining battery level of the ONU 20, and the estimation target period.

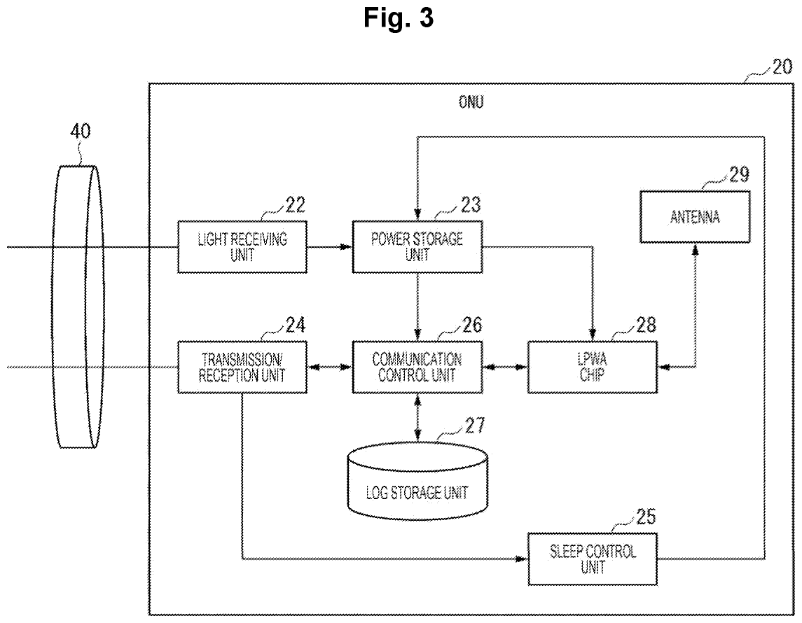

FIG. 3 is a diagram illustrating a specific configuration of the ONU 20 according to the embodiment. The ONU 20 includes a light receiving unit 22, a power storage unit 23, a transmission/reception unit 24, a sleep control unit 25, a communication control unit 26, a log storage unit 27, an LPWA chip 28, and an antenna 29. Note that the communication control unit 26 and the LPWA chip 28 are in a sleep state when not in use.

The light receiving unit 22 receives the optical signal transmitted from the optical power supply unit 11 via the optical transmission line 40, converts the received optical signal into an electrical signal, and outputs the electrical signal to the power storage unit 23. The light receiving unit 22 is an O/E converter such as a photodetector, for example.

The power storage unit 23 includes a battery therein. The power storage unit 23 stores the electrical power of electrical signals in the battery by performing charging on the basis of the electrical signal output from the light receiving unit 22. In accordance with an instruction from the sleep control unit 25, the power storage unit 23 supplies a power supply voltage generated with the stored electrical power, to the communication control unit 26 and the LPWA chip 28. As a result, the communication control unit 26 and the LPWA chip 28 transition from a sleep state to an operable state.

The transmission/reception unit 24 transmits and receives data to and from the OLT 10. The transmission/reception unit 24 includes an optical transceiver, for example, and includes a light source that emits light of a specific wavelength inside. The transmission/reception unit 24 converts communication light by modulating light emitted from the light source provided therein on the basis of an electrical signal of the communication log output from the communication control unit 26, and transits the converted communication light to the optical transmission line 40.

The transmission/reception unit 24 further includes an O/E converter such as a photodetector therein. The transmission/reception unit 24 receives the optical signal of the sleep cancellation signal received via the optical transmission line 40, converts the received optical signal of the sleep cancellation signal into an electrical signal with the O/E converter, and outputs the electrical signal to the sleep control unit 25.

The sleep control unit 25 controls the functional units in a sleep state to enter an activated state, in accordance with the sleep cancellation signal received by the transmission/reception unit 24. Specifically, the sleep control unit 25 controls the functional units in a sleep state to enter an activated state at the timing when a time included in the sleep cancellation signal has come.

The communication control unit 26 is a functional unit that can operate on the electrical power supplied from the power storage unit 23. Therefore, the communication control unit 26 is in a sleep state in a case where electrical power is not supplied from the power storage unit 23. In a case where electrical power is supplied from the power storage unit 23, the communication control unit 26 transitions from the sleep state to an activated state. The communication control unit 26 processes the signal received by the transmission/reception unit 24, and a signal received by the antenna 29 and input to the LPWA chip 28.

For example, the communication control unit 26 acquires the communication log, on the basis of the signal received by the antenna 29 and input to the LPWA chip 28. The communication control unit 26 stores the acquired communication log into the log storage unit 27. For example, the communication control unit 26 transmits the communication log stored in the log storage unit 27 to the OLT 10 via the transmission/reception unit 24.

The log storage unit 27 stores the communication log acquired by the communication control unit 26. The log storage unit 27 is formed with a storage device such as a magnetic storage device or a semiconductor storage device.

The LPWA chip 28 is a functional unit that can operate on the electrical power supplied from the power storage unit 23. Therefore, the LPWA chip 28 is in a sleep state in a case where electrical power is not supplied from the power storage unit 23. In a case where electrical power is supplied from the power storage unit 23, the LPWA chip 28 transitions from the sleep state to an activated state. The LPWA chip 28 communicates with the wireless terminals 30 by LPWA via the antenna 29.

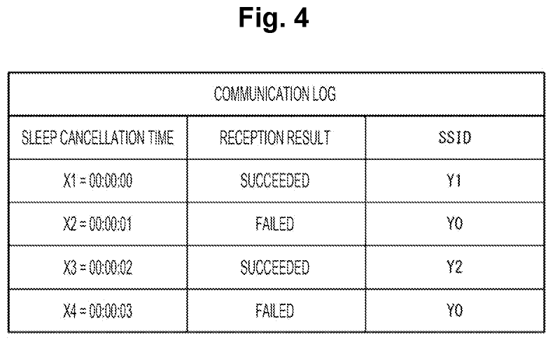

Next, an example of learning to be performed by the learning unit 15 is described with reference to FIG. 4. This example is based on the assumption that the communication log shown in FIG. 4 is stored in the log storage unit 14. FIG. 4 is a table illustrating an example of communication logs according to the embodiment. In FIG. 4, sleep cancellation times, reception results, and the respective values of SSIDs are registered as the communication log, and are associated with each other. A sleep cancellation time indicates a time at which a sleep state of the ONU 20 was canceled. A reception result indicates whether reception was successful in a state where a sleep state of the ONU 20 was canceled (or was in an operable state). The value of an SSID represents an identification name of a network to which the wireless terminal 30 is connected. Note that, in a case where communication has failed, the ONU 20 cannot obtain the SSID information. Therefore, in a case where communication has failed, a preset value (Y0 in FIG. 4) indicating the failure of the communication is used, instead of the SSID of the wireless terminal 30 at a time of successful communication.

FIG. 4 shows that communication was successful at 00:00:00, and the obtained SSID is Y1. On the other hand, communication failed at 00:00:01, and the value of Y0 is set because any SSID was not acquired, as shown in the drawing. Using the communication log illustrated in FIG. 4, the learning unit 15 learns the correspondence between the learning data and the training data, such as the successful data reception from SSID of Y1 at time X1, and the data reception failure at time X2, for example.

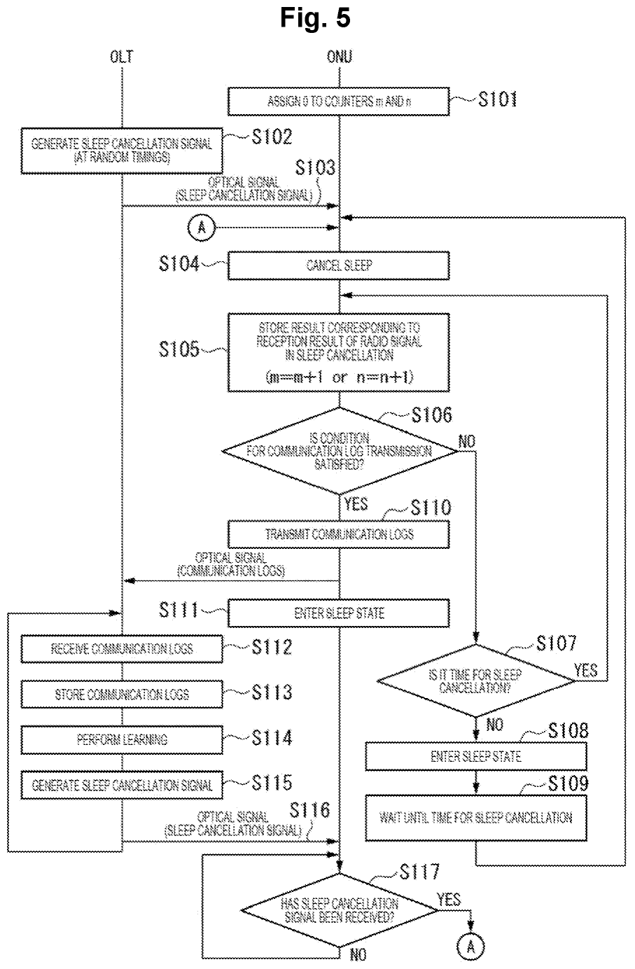

FIG. 5 is a sequence diagram illustrating the flow of processing to be performed by the optical power supply system 100 according to the embodiment. Note that the flow in generation of a learned model in an initial stage is now described with reference to FIG. 5. Note that any learned model is not stored in the OLT 10 at the processing start time in FIG. 5.

The communication control unit 26 of the ONU 20 assigns an initial value “0” to counters m and n (step S101). Here, the counters m and n each represent the number of communication logs stored in the log storage unit 27. For example, the counter m represents the number of communication logs indicating that communication was successful (reception results indicating “succeeded”), and the counter n represents the number of communication logs indicating that communication failed (reception results indicating “failed”).

The control unit 13 instructs the control signal generation unit 18 to generate a sleep cancellation signal. Being in the initial stage, the control unit 13 instructs the control signal generation unit 18 to perform sleep cancellation at random, for example. The control signal generation unit 18 generates the sleep cancellation signal in accordance with the instruction from the control unit 13 (step S102). For example, the control signal generation unit 18 generates the sleep cancellation signal including information about a plurality of times randomly selected from among times after the current time. The control signal generation unit 18 outputs the generated sleep cancellation signal to the data transmission/reception unit 12.

The data transmission/reception unit 12 converts the sleep cancellation signal output from the control signal generation unit 18 into an optical signal, and transmits the optical signal to the ONU 20 via the optical transmission line 40.

The transmission/reception unit 24 of the ONU 20 receives the optical signal transmitted from the OLT 10. The transmission/reception unit 24 converts the received optical signal into a sleep cancellation signal that is an electrical signal. The transmission/reception unit 24 outputs the sleep cancellation signal to the sleep control unit 25. At a time included in the sleep cancellation signal, the sleep control unit 25 controls the power storage unit 23 to cancel the sleep state of the communication control unit 26 and the LPWA chip 28 (step S104).

When the sleep state of the communication control unit 26 and the LPWA chip 28 is canceled, wireless communication between the ONU 20 and the wireless terminals 30 is enabled. The communication control unit 26 stores, into the log storage unit 27, a result corresponding to the reception result of a radio signal in sleep cancellation (step S105). For example, in a case where a signal transmitted from a wireless terminal 30 is received via the antenna 29 at the time when the sleep state is canceled, the communication control unit 26 acquires the SSID of the wireless terminal 30 from the received signal, and stores, into the log storage unit 27, an additional communication log that includes the acquired SSID, the sleep cancellation time, and information indicating that the reception of the radio signal is successful, which are associated with each other. At this point of time, the communication control unit 26 adds 1 to the value of the counter m.

On the other hand, in a case where a signal transmitted from a wireless terminal 30 has not been received via the antenna 29 at the time when the sleep state is canceled, the communication control unit 26 stores, into the log storage unit 27, an additional communication log that includes the sleep cancellation time, information indicating that the reception of the radio signal has failed, and a value indicating that the communication has failed, which are associated with each other. At this point of time, the communication control unit 26 adds 1 to the value of the counter n.

After that, the communication control unit 26 determines whether the condition for communication log transmission is satisfied (step S106). The condition for communication log transmission is that the values of the counter m and the counter n are equal to or greater than a predetermined number (m≥Tm, n≥Tn, for example). Note that the condition for communication log transmission may be any condition that is satisfied when a certain amount or more of communication logs indicating that communication has succeeded and communication logs indicating that communication has failed are accumulated. Tm and Tn may be the same values, or may be different values.

If the condition for communication log transmission is not satisfied (step S106—NO), the sleep control unit 25 determines whether the current time is a time included in the sleep cancellation signal (step S107). If the current time is a time included in the sleep cancellation signal (step S107—YES), the ONU 20 perform the process in step S105.

If the current time is not a time included in the sleep cancellation signal (step S107—NO), on the other hand, the sleep control unit 25 controls the power storage unit 23 to put the communication control unit 26 and the LPWA chip 28 into a sleep state (step S108). When the communication control unit 26 and the LPWA chip 28 transition to a sleep state, the sleep control unit 25 waits until a time included in the sleep cancellation signal comes. At a time included in the sleep cancellation signal, the sleep control unit 25 then controls the power storage unit 23 to cancel the sleep state of the communication control unit 26 and the LPWA chip 28 (step S104). After that, the processes in step S105 and the subsequent steps are performed.

If the condition for communication log transmission is satisfied in the process in step S106 (step S106—YES), the communication control unit 26 acquires all the communication logs stored in the log storage unit 27. The communication control unit 26 outputs all the acquired communication logs to the transmission/reception unit 24. Note that the communication control unit 26 may delete the acquired communication logs from the log storage unit 27. The transmission/reception unit 24 converts the plurality of communication logs output from the communication control unit 26 into an optical signal, and transmits the optical signal to the OLT 10 via the optical transmission line 40 (step S110). After that, the sleep control unit 25 controls the power storage unit 23 to put the communication control unit 26 and the LPWA chip 28 into a sleep state (step S111).

The data transmission/reception unit 12 of the OLT 10 receives the optical signal transmitted from the ONU 20 (step S112). The data transmission/reception unit 12 converts the received optical signal into communication logs in the form of an electrical signal. The data transmission/reception unit 12 outputs the communication logs to the control unit 13. The control unit 13 stores the communication logs received by the data transmission/reception unit 12 into the log storage unit 14 (step S113). The learning unit 15 generates a learned model by performing learning, using the communication logs stored in the log storage unit 14 (step S114). The learning unit 15 stores the generated learned model into the learned model storage unit 16.

The control signal generation unit 18 generates a sleep cancellation signal on the basis of the learned model stored in the learned model storage unit 16 (step S115). The process of generating a sleep cancellation signal on the basis of a learned model will be described later. The control signal generation unit 18 outputs the generated sleep cancellation signal to the data transmission/reception unit 12. The data transmission/reception unit 12 converts the sleep cancellation signal output from the control signal generation unit 18 into an optical signal, and transmits the optical signal to the ONU 20 via the optical transmission line 40 (step S116). After that, the OLT 10 updates the learned model by performing learning each time communication logs are received from the ONU 20. Updating the learned model means adjusting again the coefficients to be used in the machine learning model so as to minimize the loss function.

The sleep control unit 25 of the ONU 20 determines whether the sleep cancellation signal has been received (step S117). If the sleep cancellation signal has not been received (step S117—NO), the ONU 20 waits in a sleep state until the sleep cancellation signal is received. If the sleep cancellation signal has been received (step S117—YES), on the other hand, the sleep control unit 25 controls the power storage unit 23 to cancel the sleep state of the communication control unit 26 and the LPWA chip 28, at a time included in the sleep cancellation signal (step S104). After that, the ONU 20 performs the processes in and after step S105.

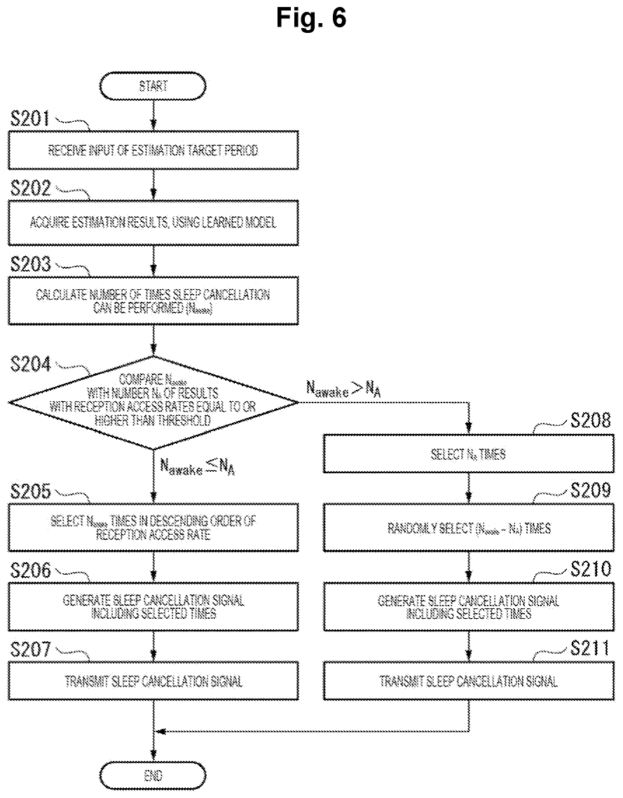

FIG. 6 is a flowchart illustrating the flow of a sleep cancellation signal generation process to be performed by the OLT 10 according to the embodiment. At the start of the process illustrated in FIG. 6, a learned model is already stored in the learned model storage unit 16.

The control signal generation unit 18 receives an input of an estimation target period (step S201). Information about the estimation target period may be input to the OLT 10 by the user operating the OLT 10 or an external device. For example, as for the estimation target period, the current time is “00:00:03”, and information indicating “estimation at one-second intervals till five seconds ahead of the current time” is input.

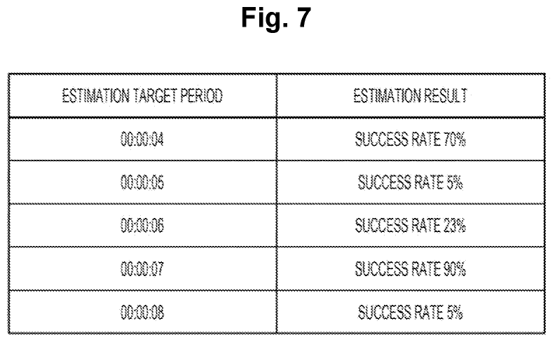

The control signal generation unit 18 inputs the estimation target period to the learned model stored in the learned model storage unit 16, and acquires estimation results. In a case where the above estimation target period is input to the learned model, estimation results at the respective times “00:00:04”, “00:00:05”, “00:00:06”, “00:00:07”, and “00:00:08” are obtained. FIG. 7 is a table illustrating an example of estimation results obtained from a learned model.

FIG. 7 shows that, within the estimation target period, the estimation result at “00:00:04” is “success rate 70%”, the estimation result at “00:00:05” is “success rate 5%”, the estimation result at “00:00:06” is “success rate 23%”, the estimation result at “00:00:07” is “success rate 90%”, and the estimation result at “00:00:08” is “success rate 5%”.

Next, the control signal generation unit 18 calculates the number N_{awake} of times the ONU 20 can perform sleep cancellation, on the basis of the remaining battery level of the ONU 20 and the power consumption information stored in the setting value storage unit 17 (step S203). For example, in a case where the power consumption indicated by the power consumption information is 50 mAh and the remaining battery level is 110 mAh, the number N_{awake} of times sleep cancellation can be performed is two.

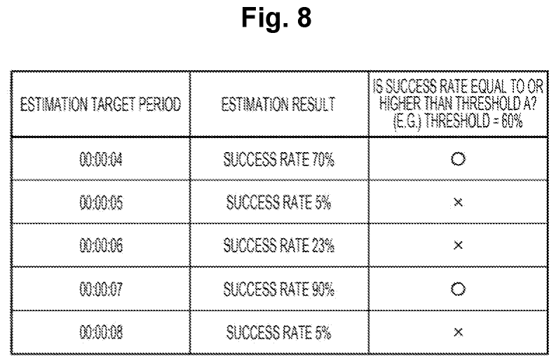

Next, the control signal generation unit 18 refers to the estimation results obtained by the learned model, and calculates the number N_{A} of estimation results in which the success rate exceeds the threshold stored in the setting value storage unit 17 (these estimation results will be hereinafter referred to as “successful estimation results”). Here, in a case where the threshold is 60%, and the results shown in FIG. 7 have been obtained, the number N_{A} of successful estimation results is two as shown in FIG. 8. FIG. 8 is a table illustrating the relationship between estimation results and the threshold according to the embodiment.

Next, the control signal generation unit 18 compares the number N_{awake} of times sleep cancellation can be performed, with the number N_{A} of successful estimation results (step S204). If the number N_{awake} of times sleep cancellation can be performed is equal to or smaller than the number N_{A} of successful estimation results (step S204—N_{awake}≤N_{A}), the control signal generation unit 18 selects the times associated with the estimation results showing the number N_{awake} of times (twice, for example) sleep cancellation can be performed, in descending order of reception success rate (step S205). In the case of the results shown in FIG. 8, the control signal generation unit 18 selects “00:00:04” and “00:00:07” associated with the estimation results “70%” and “90%” within the estimation target period.

The control signal generation unit 18 generates a sleep cancellation signal including the selected times (step S206). The control signal generation unit 18 outputs the generated sleep cancellation signal to the data transmission/reception unit 12. The data transmission/reception unit 12 converts the sleep cancellation signal output from the control signal generation unit 18 into an optical signal, and transmits the optical signal to the ONU 20 via the optical transmission line 40 (step S207).

In the process in step S204, if the number N_{awake} of times sleep cancellation can be performed is larger than the number N_{A} of successful estimation results (step S204—N_{awake}>N_{A}), the control signal generation unit 18 selects the times associated with the estimation results showing that the number of successful estimation results is N_{A} (twice, for example) (step S208). Note that, although the number of successful estimation results is N_{A} at the times when the success rate is equal to or higher than the threshold, the ONU 20 can perform sleep cancellation the number of times (“N_{awake}−N_{A}” times) equivalent to the difference between the number of times sleep cancellation can be performed and the number N_{A} of successful estimation results. Therefore, the control signal generation unit 18 randomly selects “N_{awake}−N_{A}” times (step S209). At this point of time, the control signal generation unit 18 may select times at which any estimation result has not been obtained (times after “00:00:08”, for example, in the example shown in FIG. 7), or may randomly select from among the times at which estimation results have been obtained.

The control signal generation unit 18 generates a sleep cancellation signal including the times selected in the processes in steps S208 and S209 (step S210). The control signal generation unit 18 outputs the generated sleep cancellation signal to the data transmission/reception unit 12. The data transmission/reception unit 12 converts the sleep cancellation signal output from the control signal generation unit 18 into an optical signal, and transmits the optical signal to the ONU 20 via the optical transmission line 40 (step S211).

Note that, in a case where sleep cancellation by the ONU 20 is performed in the process shown in FIG. 6, the OLT 10 can acquire communication logs from the ONU 20 if the condition for communication log transmission is satisfied. In this case, the communication logs are newly stored into the log storage unit 14 of the OLT 10. In view of this, the learning unit 15 may be designed to learn the learned model again, using the newly obtained communication logs. With such a configuration, it is possible to increase the accuracy of outputs (estimation results) of the learned model.

As an example of the processes in steps S208 and S209, an example case where the number N_{awake} of times sleep cancellation can be performed is five, and the number N_{A} of successful estimation results is two as shown in FIG. 8 is now described. In this case, even if the ONU 20 is notified of a sleep cancellation signal including “00:00:04” and “00:00:07”, which are the times selected as the number N_{A} of successful estimation results, the number N_{awake} of times sleep cancellation can be performed is five, and accordingly, the ONU 20 can further perform sleep cancellation three times. In view of this, the ONU 20 randomly selects three more appropriate times, and the ONU 20 is notified of a sleep cancellation signal including the three randomly selected times and the two times selected as the number N_{A} of successful estimation results. As a result, the ONU 20 performs sleep cancellation at the two times (“00:00:04” and “00:00:07”) with high estimated success rates, and at the three appropriately selected times.

The reason for add randomly selected times as described above is to collect the learning data at unknown times, to make the learned model more intelligent. If sleep cancellation is performed at N_{A} times equivalent to the number of the highly successful estimation results in descending order of the estimated values of success rates without the use of a threshold, a biased inaccurate estimation result is output with the learned model in a case where learning by the learning unit 15 is not successful. If the OLT 10 transmits a sleep cancellation instruction to the ONU 20 on the basis of the estimation results obtained in accordance with such a learned model, the possibility of failed reception would be high.

Where sleep cancellation is performed also at random times, on the other hand, trial data of sleep cancellation becomes more diverse, and the probability of generation of training data for “successful reception” becomes higher, which is expected to facilitate the learning.

The optical power supply system 100 designed as described above includes: the control signal generation unit 18 that generates, on the basis of a communication log, a sleep cancellation signal including information about at least one time at which communication between the ONU 20 and a wireless terminal 30 is expected to be successful, the communication log including information about results of communication performed while a sleep state of the ONU 20 is canceled; and the data transmission/reception unit 12 that converts the generated sleep cancellation signal into an optical signal, and transmits the optical signal to the ONU 20. With this configuration, a sleep state of the ONU 20 can be canceled at a time when communication with a wireless terminal 30 is expected to be successful. Further, in a case where communication with any of the wireless terminals 30 is not performed, it is possible to put the ONU 20 into a sleep state. Thus, it is possible to increase the reception success rate of uplink signals with less power in the optical communication device that communicates with a terminal device that transmits uplink signals.

Further, the control signal generation unit 18 receives an input of an estimation target period, acquires at least one estimation result using a learned model learned to output a result of estimation of the reception success rate of the wireless terminal 30 at each of the times indicated by the input estimation target period, and acquires the information about the at least one time on the basis of the at least one estimation result acquired. Using the learned model that has been learned beforehand in this manner, it is possible to easily obtain results of estimation of reception success rates. Accordingly, the times for canceling sleep of the ONU 20 can be selected on the basis of the obtained results of estimation of reception success rates. Because of this, sleep of the ONU 20 can be canceled at the timings when the reception success rate is high. Thus, it is possible to increase the reception success rate of uplink signals with less power in the optical communication device that communicates with a terminal device that transmits uplink signals.

In the description below, modifications are explained.

The embodiment described above concerns a configuration in which the OLT 10 includes the learning unit 15 and generates a learned model. The learning unit 15 may be installed in another device, and the OLT 10 may be designed to perform the processes described above, using a learned model generated by the other device. In such a configuration, the OLT 10 transmits communication logs to the other device, and receives data of the learned model from the other device.

In FIG. 6, in a case where the number N_{awake} of times sleep cancellation can be performed is equal to or smaller than the number N_{A} of successful estimation results, sleep cancellation at random times may also be mixed into the sleep cancellation signal in order to increase the diversity of sleep cancellation times and accelerate the progress of learning. For example, in a case where the number N_{awake} of times sleep cancellation can be performed is three, and the number N_{A} of successful estimation results is three, the control signal generation unit 18 may select the times associated with two estimation results (in descending order of success rate, for example) one fewer than the three successful estimation results, instead of selecting all the times associated with the three successful estimation results, also select one random time, and generate a sleep cancellation signal including a total of three times.

Some functional units in the OLT 10 and the ONU 20 in the embodiment described above may be implemented by a computer. In that case, a program for implementing the functions may be recorded in a computer-readable recording medium, and the program recorded in the recording medium may be read and executed by a computer system to implement the functions. Note that the “computer system” mentioned herein includes an OS and hardware such as peripheral devices. Also, the “computer-readable recording medium” is a portable medium such as a flexible disk, a magneto-optical disc, a ROM, or a CD-ROM, or a storage device such as a hard disk included in the computer system. Further, the “computer-readable recording medium” may be a medium that dynamically stores the program for a short time, such as a communication line in a case where the program is transmitted via a network such as the Internet or a communication line such as a telephone line, or may be a medium that stores the program for a certain period of time, such as a volatile memory in the computer system serving as a server or a client in that case. Also, the program may be for implementing some of the functions described above, may be implemented in combination with the functions described above and a program already recorded in the computer system, or may be implemented with a programmable logic device such as a field programmable gate array (FPGA).

Although the embodiment of the present invention has been described in detail with reference to the drawings, specific configurations are not limited to the embodiment, and include designs and the like within the scope of the present invention.

### INDUSTRIAL APPLICABILITY

The present invention can be applied to optical communication systems that perform optical power supply.

### REFERENCE SIGNS LIST

10 OLT
20 ONU (power-receiving optical communication device)
30, 30-1, 30-2 wireless terminal
11 optical power supply unit
12 data transmission/reception unit
13 control unit
14 log storage unit
15 learning unit
16 learned model storage unit
17 setting value storage unit
18 control signal generation unit
22 light receiving unit
23 power storage unit
24 transmission/reception unit
25 sleep control unit
26 communication control unit
27 log storage unit
28 LPWA chip
29 antenna

1. An optical communication device comprising:
a processor; and
a storage medium having computer program instructions stored thereon, when executed by the processor, perform to:
generates, on a basis of a communication log, a sleep cancellation signal including information about at least one time at which communication with a terminal device performing wireless communication with a power-receiving optical communication device is expected to be successful, the communication log including information about a result of communication at a time when sleep state cancellation is performed on the power-receiving optical communication device that is driven by electrical power obtained from an optical signal for power supply; and
converts the generated sleep cancellation signal into an optical signal, and transmits the optical signal to the power-receiving optical communication device.

2. The optical communication device according to claim 1, wherein the computer program instructions further perform to
receives an input of period information regarding a period during which estimation for sleep cancellation is to be performed, acquires at least one estimation result using a learned model learned to output a result of estimation of a reception success rate of the power-receiving optical communication device at each time indicated by the input period information, and acquires the information about the at least one time on a basis of the at least one estimation result acquired.

3. The optical communication device according to claim 2, wherein the computer program instructions further perform to
identifies a successful estimation result showing the reception success rate equal to or higher than a threshold value from among the at least one estimation result acquired, and generates the sleep cancellation signal including information about at least one time associated with the identified successful estimation result.

4. The optical communication device according to claim 3, wherein the computer program instructions further perform to
calculates a number of cancellation enabled times indicating a number of times at which sleep cancellation can be performed in the power-receiving optical communication device, on a basis of power information indicating remaining power of the power-receiving optical communication device and information about electrical power to be consumed by sleep cancellation, compares the calculated number of cancellation enabled times with the successful estimation result, and determines the information about the at least one time to be included in the sleep cancellation signal in accordance with a comparison result.

5. The optical communication device according to claim 4, wherein the computer program instructions further perform to,
when the number of cancellation enabled times is equal to or smaller than the number of the successful estimation results,
selects the successful estimation results as many as the number of cancellation enabled times in descending order of the reception success rate, and generates the sleep cancellation signal including the information about the times associated with the selected successful estimation results,
or
selects the successful estimation results fewer than the number of cancellation enabled times in descending order of the reception success rate, and generates the sleep cancellation signal including the information about the times associated with the selected successful estimation results and information about a randomly selected time.

6. The optical communication device according to claim 4, wherein the computer program instructions further perform to,
when the number of cancellation enabled times is larger than the number of the successful estimation results,
randomly determines information about new times corresponding to a difference between the number of cancellation enabled times and the number of the successful estimation results, and generates the sleep cancellation signal including the determined information about the new times and information about the times associated with the successful estimation results.

7. The optical communication device according to claim 1, wherein
the communication log includes information about a cancellation time at which a sleep state of the power-receiving optical communication device has been canceled, and a name of a network to which the terminal device is connected, and
the optical communication device further comprises a learning unit that generates the learned model, using learning data including the information about the cancellation time, and training data including the name of the network and the information about the result of communication.

8. A sleep control method comprising:
generating, on a basis of a communication log, a sleep cancellation signal including information about at least one time at which communication with a terminal device performing wireless communication with a power-receiving optical communication device is expected to be successful, the communication log including information about a result of communication at a time when sleep state cancellation is performed on the power-receiving optical communication device that is driven by electrical power obtained from an optical signal for power supply; and
converting the generated sleep cancellation signal into an optical signal, and transmitting the optical signal to the power-receiving optical communication device.
